(19) United States
(12) Patent Application Publication
(10) Pub. No.: US 2025/0265548 A1
(43) Pub. Date: Aug. 21, 2025

(54) SOFTWARE DEVELOPMENT PROCESS CONTROLLER

(71) Applicant: Capital One Services, LLC, McLean, VA (US)

(72) Inventors: Jonathan CHEN, Chino Hills, CA (US); Carel DE BRUYN, Prosper, TX (US); James ANTHONYRAJ, Coppell, TX (US); Alex LEUNG, Plano, TX (US); David DUONG, Plano, TX (US); Jose GOMEZ, San Diego, CA (US)

(21) Appl. No.: 18/582,221

(22) Filed: Feb. 20, 2024

(51) Int. Cl. G06Q 10/10; G06F 8/10; G06F 8/30; G06F 8/60; G06Q 10/109

(52) U.S. Cl. CPC G06Q 10/103; G06F 8/10; G06F 8/30; G06F 8/60; G06Q 10/109

(57) ABSTRACT

In some implementations, a device may receive via a form, a set of requirements associated with generation of program code. The device may generate a program code generation item based on the set of requirements. The device may store, via a first system, the program code generation item. The device may generate program code for the program code generation item based on the set of requirements. The device may receive information identifying a new requirement for the program code generation item. The device may obtain an approval of the new requirement. The device may generate updated program code for the program code generation item based on the new requirement and based on obtaining the approval. The device may store the updated program code in the first system in connection with the program code generation item.

### BACKGROUND

A software development lifecycle may include a set of phases for development of software components. For example, the software development lifecycle may include a planning phase, a design phase, a testing phase, and/or a deployment phase, among other examples. In the planning phase, a set of requirements or functionalities may be determined for a software development project, such as development of a new software component or adding a functionality to an existing software component. Many entities (such as software users, software developers, or software testers, among other examples) may interact and exchange messages during the planning phase.

### SUMMARY

Some implementations described herein relate to a system for process control. The system may include one or more memories and one or more processors communicatively coupled to the one or more memories. The one or more processors may be configured to receive, via a first interface, a set of parameters for a software development project associated with generating program code. The one or more processors may be configured to generate a new software development project item for the software development project based on the set of parameters. The one or more processors may be configured to store, via a first system associated with a second interface, the new software development project item. The one or more processors may be configured to generate a monitored communication channel, operating on a second system, for the new software development project. The one or more processors may be configured to provision, on the second system, access to the monitored communication channel to a set of client devices associated with the software development project. The one or more processors may be configured to receive, based on a set of commands in the monitored communication channel, information identifying a new parameter for the software development project. The one or more processors may be configured to update the new software development project item in the first system based on the new parameter. The one or more processors may be configured to provide information associated with updating the new software development project item.

Some implementations described herein relate to a non-transitory computer-readable medium that stores a set of instructions. The set of instructions, when executed by one or more processors of a system, may cause the system to provide, to a client device, a user interface including a set of fields for receiving data. The set of instructions, when executed by one or more processors of the system, may cause the system to receive, via a user interface, a set of values for the set of fields. The set of instructions, when executed by one or more processors of the system, may cause the system to generate a new data item including the set of values for the set of fields. The set of instructions, when executed by one or more processors of the system, may cause the system to store, via a data structure of a first system, the new data item. The set of instructions, when executed by one or more processors of the system, may cause the system to generate, for the new data item and in connection with a second system, a communication channel. The set of instructions, when executed by one or more processors of the system, may cause the system to provision, for a set of client devices, access to the communication channel on the second system. The set of instructions, when executed by one or more processors of the system, may cause the system to receive, via the communication channel of the second system, information identifying a set of commands. The set of instructions, when executed by one or more processors of the system, may cause the system to parse the set of commands to determine a change to a value of the set of values. The set of instructions, when executed by one or more processors of the system, may cause the system to transmit an update notification to the first system to update the value in the new data item. The set of instructions, when executed by one or more processors of the system, may cause the system to transmit an update confirmation to the second system, for inclusion in the communication channel, indicating the update of the value of the new data item.

Some implementations described herein relate to a method. The method may include receiving, by a device, via a form, a set of requirements associated with generation of program code. The method may include generating, by the device, a program code generation item based on the set of requirements. The method may include storing, by the device and via a first system, the program code generation item. The method may include generating, by the device, program code for the program code generation item based on the set of requirements. The method may include receiving, by the device, information identifying a new requirement for the program code generation item. The method may include obtaining, by the device, an approval of the new requirement. The method may include generating, by the device, updated program code for the program code generation item based on the new requirement and based on obtaining the approval. The method may include storing, by the device, the updated program code in the first system in connection with the program code generation item.

### BRIEF DESCRIPTION OF THE DRAWINGS

FIGS. 1A-1C are diagrams of an example implementation associated with software development process control, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with software development process control, in accordance with some embodiments of the present disclosure.

FIG. 4 is a flowchart of an example process associated with software development process control, in accordance with some embodiments of the present disclosure.

### DETAILED DESCRIPTION

The following detailed description of example implementations refers to the accompanying drawings. The same reference numbers in different drawings may identify the same or similar elements.

A software development lifecycle may include a set of phases, such as a software development phase, a software deployment phase, and/or a software maintenance phase. The software development phase may include a planning phase, a design phase, or a testing phase, among other examples. The planning phase may include a determination of a set of requirements for a new software component and/or a determination of a set of computing resources to be allocated to generating code for implementing the set of requirements for the new software component. New software components may be developed to provide new functionalities for computing systems. Similarly, during the software maintenance phase, new functionalities may be identified for implementation in existing software components.

A software development process, for developing new software components or for developing new functionalities for existing software components, can be resource intensive. For example, manual code generation may involve assigning resources to tens, hundreds, or thousands of client devices for use by developers in writing, testing, and debugging code. Similarly, automatic code generation (e.g., as may occur when using an artificial intelligence (AI) or large language model (LLM) code generator) may involve assigning computing resources to, for example, a cloud computing environment that is used to generate, test, and debug code. When there is an inconsistency in a set of requirements for a software component under development (e.g., a new software component or an existing software component), the software development process may include repetitive, unnecessary revisions to program code. For example, an automatic code generation component may generate first program code to fulfill a first requirement, but may determine that a second requirement conflicts with the first requirement. This may result in ambiguity regarding whether to include the first program code in the software component or generate second program code based on the second requirement.

Some implementations described herein provide a software development process controller to automatically control the software development process, thereby avoiding ambiguities or conflicts arising in a set of requirements for the software development process. For example, a process control system may obtain project information for a project, generate new project information based on the project information, provision a communication channel for communications relating to the project, identify changes to the project information, determine whether to approve changes to the project information, and periodically update the project based on approving changes to the project information. As a result, by enforcing a set of rules relating to project information changes, such as requirements changes, the process control system avoids ambiguities or conflicts in the project information. By avoiding ambiguities or conflicts in the project information, the process control system enables automated code generation for software development projects. Additionally, or alternatively, by avoiding ambiguities or conflicts in the project information, the process control system enables automatic or manual code generation with reduced resources, by reducing a likelihood of conflicting code relating to conflicting requirements, reducing a likelihood of testing errors from conflicting code, and reducing a likelihood of debugging relating to the testing errors.

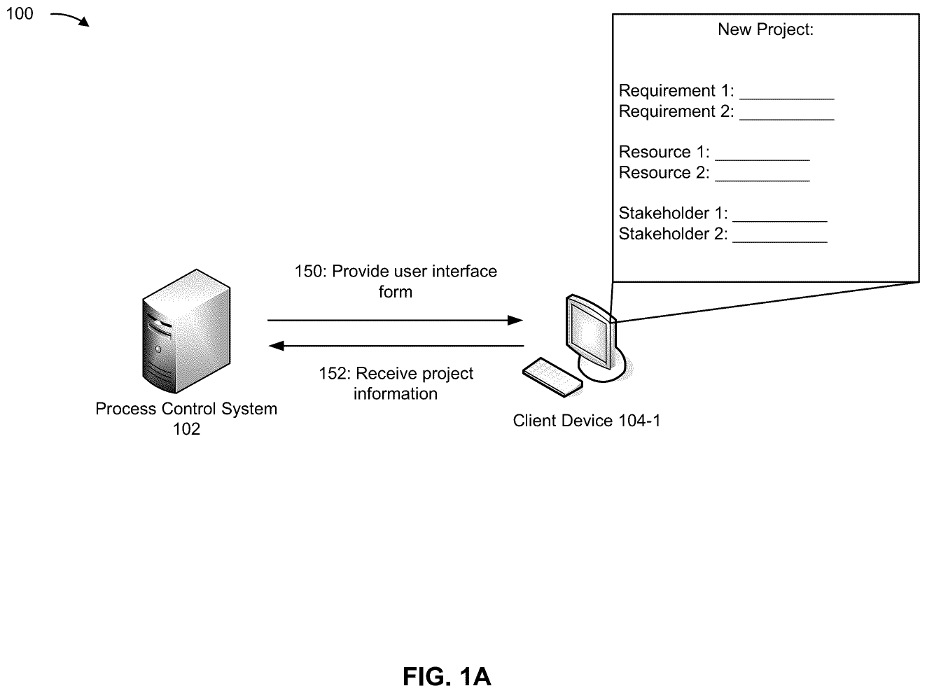

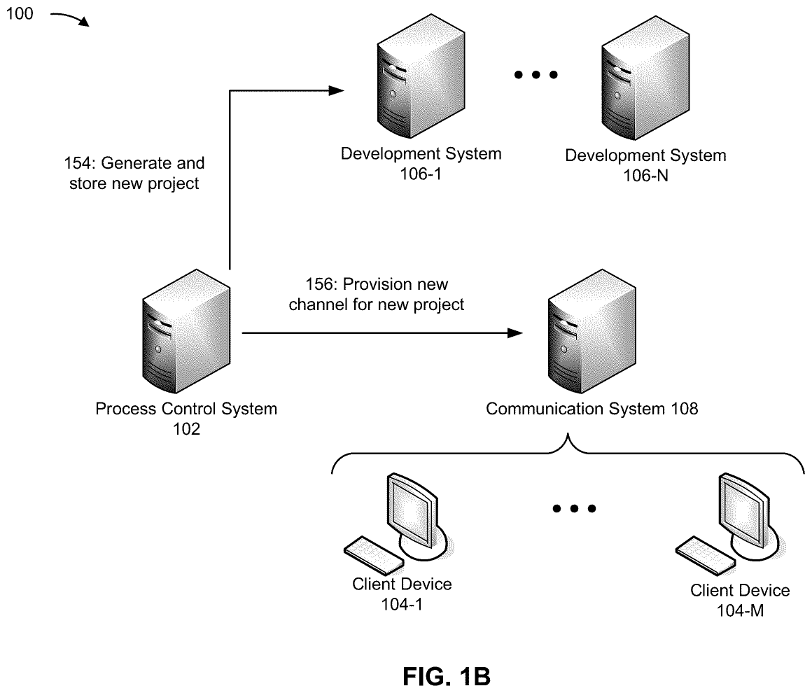

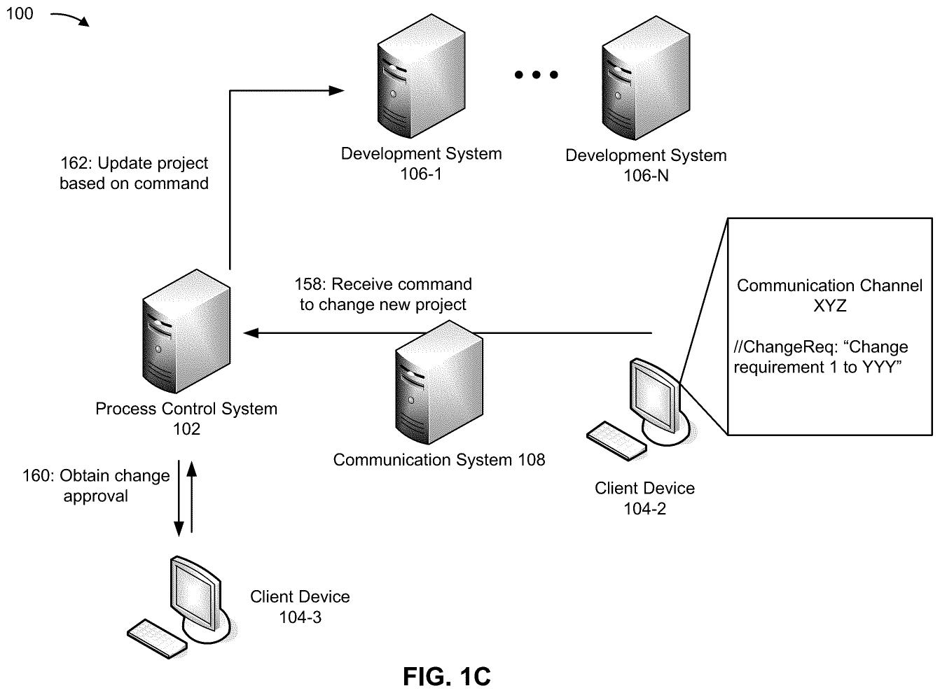

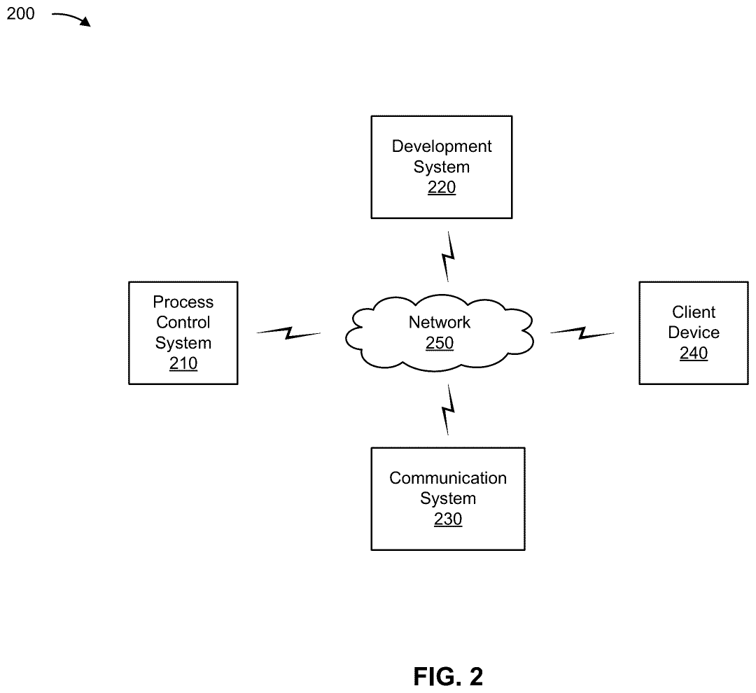

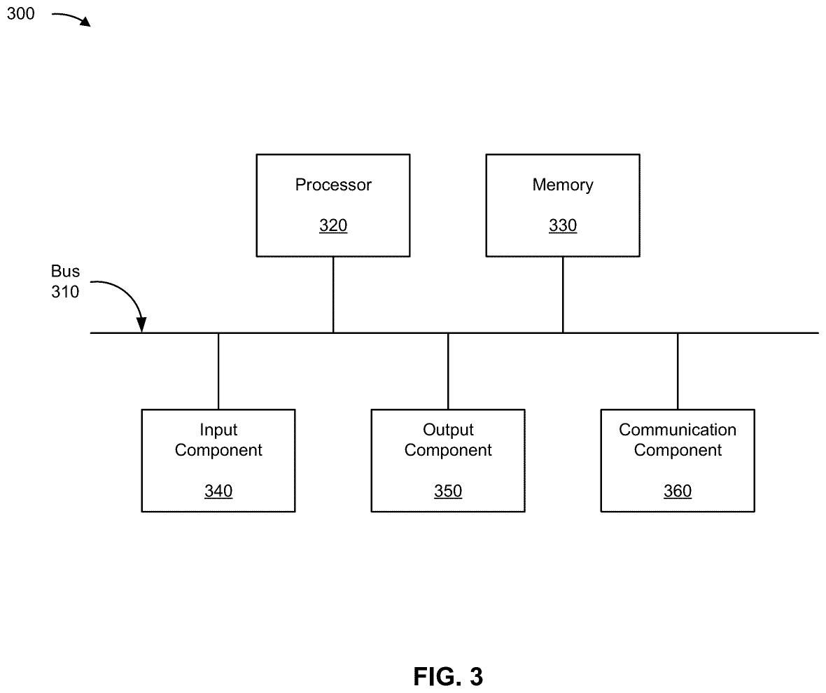

FIGS. 1A-1C are diagrams of an example implementation 100 associated with software development process control. As shown in FIGS. 1A-1C, example implementation 100 includes a process control system 102, a set of client devices 104, a set of development systems 106, and a communication system 108. These devices are described in more detail below in connection with FIG. 2 and FIG. 3.

As shown in FIG. 1A, and by reference number 150, the process control system 102 may provide information for display via a client device 104-1. For example, the process control system 102 may cause a form to be provided for display via a user interface of the client device 104-1. In some implementations, the process control system 102 may cause the form to be provided via a serverless web application. In this case, the process control system 102 may detect one or more user interactions with the serverless web application associated with specifying one or more parameters of a new project.

In some implementations, the process control system 102 may provide intake information (e.g., a form with a set of fields) corresponding to a set of parameters of a new project that is to be completed. The project may include a software development project for a new software component or for a new functionality to be added to an existing software component. For example, the process control system 102 may provide a form that includes a field for receiving a project identifier (e.g., a name of a project), a timeline (e.g., a date by which the project is to be completed), a project description (e.g., a set of requirements or functionalities to be implemented in the project), or an organizational plan (e.g., which stakeholders have approval authority for the project), among other examples.

As further shown in FIG. 1A, and by reference number 152, the process control system 102 may receive project information from the client device 104-1. For example, the process control system 102 may receive a set of values entered into the form that is provided for display via the user interface of the client device 104-1. In some implementations, the process control system 102 may receive information describing a new project in plain language. For example, the process control system 102 may receive a plain language description of a functionality that is to be implemented in a software development project. In this case, the process control system 102 may parse the plain language description of the functionality, such as using a natural language processing function, to generate a set of requirements for the project based on the plain language description.

Additionally, or alternatively, the process control system 102 may process the project information to derive a set of stakeholders for the project. For example, when an approval authority (e.g., a user with authority to approve project changes) is not specified for the project, the process control system 102 may parse an organizational flow chart to determine which member of an organization is to be designated as approval authority. In other words, when the project relates to a particular unit within an organization, the process control system 102 may identify a manager of the particular unit and assign the manager as the approval authority. Additionally, or alternatively, the process control system 102 may use a machine learning algorithm trained on other projects to predict who should be assigned as approval authority or categorize the project into a particular group associated with a particular approval authority. Additionally, or alternatively, the process control system 102 may determine that approval authority is automated. For example, the process control system 102 may determine that approval of changes to the project is to be made using a machine learning algorithm trained on prior changes. In other words, as described in more detail herein, when the process control system 102 receives a requested change to the project, the process control system 102 may process the requested change using a machine learning model to determine whether to approval the requested change (e.g., based on a projected amount of resources that may be used to implement the change, a projected timeline for implementing the change, or another set of factors).

As shown in FIG. 1B, and by reference number 154, the process control system 102 may generate and store a new project. For example, the process control system 102 may instantiate a new project item in one or more development systems 106-1 through 106-N. For example, the process control system 102 may access a development system 106 and generate an item (e.g., a project item) for the new project in the development system 106. In this case, the development system 106 may be an existing scheduling or management system for a project workflow and the process control system 102 may interact with the development system 106 to automatically instantiate, update, and/or control elements within the development system 106. Additionally, or alternatively, the development system 106 may be a function of the process control system 102. In other words, the process control system 102 may have a scheduling or management component, which the process control system 102 may update with an item representing the new project submitted via the form, as described above.

In some implementations, the process control system 102 may use a template to generate and store the new project. For example, the process control system 102 may be configured with (or may derive from other projects) a set of item templates (e.g., with placeholder values) corresponding to a set of different types of projects. In this case, the process control system 102 may determine a type of the new project and may select a corresponding item template. The process control system 102 may populate values in the item template to generate a new project item and may store the populated item template as the new project item.

In some implementations, the process control system 102 may call an application programming interface (API) to generate and store the new project item. For example, the process control system 102 may use one or more API calls, of the development systems 106, to instantiate the new project item or fill in one or more values or parameters in the new project item. In this case, the process control system 102 may use one or more other API calls to update the new project item, add new requirements to the new project item, or deploy the new project item, among other examples.

In some implementations, the process control system 102 may set a group of parameters in connection with generating and storing the new project. For example, the process control system 102 may identify a set of assignees for the new project. The assignees for the new project may include a set of client devices 104 associated with users that are assigned to one or more tasks of the new project. Additionally, or alternatively, the process control system 102 may divide the project into the one or more tasks for assignment to the assignees. For example, the process control system 102 may parse a set of requirements of the project to determine a set of tasks relating to the set of requirements, such as a coding task, a testing task, or a debugging task for each requirement, among other examples. In this case, the process control system 102 may automatically assign each task to an assignee (e.g., a client device 104 and an associated user). In some implementations, the process control system 102 may use a scheduling algorithm, which may be a machine learning or artificial intelligence algorithm, to assign the set of tasks. For example, the process control system 102 may rank possible assignees, using an artificial intelligence algorithm, based on associated skills, prior work product, schedule availability, or other factors, and use the ranking to assign different tasks to different assignees. In some implementations, the process control system 102 may transmit information identifying one or more calendar items to the client devices 104 (e.g., for inclusion in one or more calendars), identifying tasks to be completed or meetings associated with the project.

As further shown in FIG. 1B, and by reference number 156, the process control system 102 may provision a new channel for the new project. For example, the process control system 102 may cause a communication channel to be created and monitored in the communication system 108, and may assign the client devices 104-1 through 104-M to the communication channel. In some implementations, the process control system 102 may establish monitoring of the communication channel by the process control system 102. For example, the process control system 102 may subscribe to the communication channel or have communications in the communication channel provided to the process control system 102 for monitoring (e.g., subject to any relevant data privacy requirements and/or with anonymization of any personal information). In this case, the process control system 102 may monitor the communication channel to detect one or more commands in the communication channel, such as a modification command, a testing command, a deployment command, or a task assignment command, among other examples. For example, the process control system 102 may detect commands associated with specifying new requirements or other new project information. Additionally, or alternatively, the process control system 102 may configure the communication system 108 to monitor the communication channel. For example, the process control system 102 may identify one or more commands that the communication system 108 is to detect and may configure the communication system 108 to forward, to the process control system 102, information relating to a detection of the one or more commands.

In some implementations, the process control system 102 may monitor (or configure the communication system 108 to monitor) the communication channel for natural language descriptions relating to the project. For example, the process control system 102 may use natural language processing and/or semantic analysis to determine that a message in the communication channel indicates an update to a particular task, such as completion of the particular task. In this case, the process control system 102 may automatically include the update in the development system 106 in connection with the particular task, as described in more detail herein. In some implementations, the process control system 102 may operate a chatbot functionality that may interact with a user of a client device 104 via the communication channel. For example, the process control system 102 may use the chatbot functionality (e.g., which may be supported by an artificial intelligence algorithm or large-language model) to request additional details or to resolve conflicting instructions received via a message in the communication channel.

In some implementations, the process control system 102 may select a set of client devices 104 to provision or register with the communication channel. For example, the process control system 102 may provide access to the communication channel to one or more client devices 104 that are assigned to one or more tasks of the project. Additionally, or alternatively, the process control system 102 may provide access to the communication channel to one or more client devices 104 assigned as approval authorities for the project.

As shown in FIG. 1C, and by reference number 158, the process control system 102 may receive a command to change the new project. For example, the process control system 102 may detect, via monitoring of the communication channel, a command identifying a new requirement for the new project. In some implementations, the process control system 102 may receive the command based on detecting usage of a configured command. For example, the process control system 102 may configure a set of strings (e.g., words or other character sets) as commands and may detect usage of a command (e.g., by monitoring the communication channel directly or by monitoring indirectly, which may include receiving an indication from the communication system 108 that is performing the monitoring). Additionally, or alternatively, the process control system 102 may detect a command based on natural language processing. For example, the process control system 102 may process a natural language message in the communication channel and interpret the natural language message as a command. Additionally, or alternatively, the process control system 102 may detect a command to change the project via another type of input. For example, the process control system 102 may receive a submission via another form provided via a user interface of a client device 104. In this case, the process control system 102 may correlate the submission with the new project and interpret the submission as a command to change the new project (e.g., in connection with new project information provided via the submission of the form).

As further shown in FIG. 1C, and by reference number 160, the process control system 102 may obtain change approval. For example, based on detecting the command to change the new project, the process control system 102 may request approval of the change from a subset of client devices 104 assigned to the project. In this case, the subset of client devices 104 may include one or more client devices 104 assigned as approval authorities. For example, a user of the client device 104-3 may provide approval (e.g., based on user interaction with a user interface) and the client device 104-3 may transmit an approval indication to the process control system 102. In some implementations, the process control system 102 may perform autonomous change approval. For example, as described above, the process control system 102 may use an artificial intelligence algorithm to analyze a requested change, such as by analyzing a projected resource utilization to generate new code to fulfill the requested change, analyzing an amount of time to implement or test the requested change, analyzing whether the requested change conflicts with other aspects of the new project, or another factor. In this case, the process control system 102 may determine, based on an output of the artificial intelligence algorithm (e.g., a yes or no decision output, a score output that may or may not satisfy a threshold, or another type of output), whether to approve the change.

As further shown in FIG. 1C, and by reference number 162, the process control system 102 may update the new project based on the command. For example, the process control system 102 may include the new requirement in a project item being stored in the development systems 106-1 through 106-N. In some implementations, the process control system 102 may generate new program code for the new project based on the change. For example, the process control system 102 may use a code generation tool, such as an artificial intelligence algorithm or a large-language model (LLM), to generate code based on an initial set of requirements. In this case, when the process control system 102 receives a request to change the project (e.g., a new requirement), the process control system 102 may generate new program code or update existing program code. Additionally, or alternatively, the process control system 102 may automatically generate and execute new test cases or test scripts, perform debugging based on results of executing the new test cases or test scripts, and/or deploy a software component (e.g., to a deployment environment) based on a result of executing the new test cases or test scripts. In some implementations, the process control system 102 may communicate with a deployment system (not shown) to deploy a software component. For example, the process control system 102 may cause program code, which is being generated and/or tested in a development environment associated with a development system, to be transferred to a deployment environment associated with a deployment system. In some implementations, the deployment environment may be a cloud or web based environment. For example, the process control system 102 may cause the software component to be available via a web interface or as a serverless web application.

As indicated above, FIGS. 1A-1C are provided as an example. Other examples may differ from what is described with regard to FIGS. 1A-1C. The number and arrangement of devices shown in FIGS. 1A-1C are provided as an example. In practice, there may be additional devices, fewer devices, different devices, or differently arranged devices than those shown in FIGS. 1A-1C. Furthermore, two or more devices shown in FIGS. 1A-1C may be implemented within a single device, or a single device shown in FIGS. 1A-1C may be implemented as multiple, distributed devices. Additionally, or alternatively, a set of devices (e.g., one or more devices) shown in FIGS. 1A-1C may perform one or more functions described as being performed by another set of devices shown in FIGS. 1A-1C.

FIG. 2 is a diagram of an example environment 200 in which systems and/or methods described herein may be implemented. As shown in FIG. 2, environment 200 may include a process control system 210, a development system 220, a communication system 230, a client device 240, and a network 250. Devices of environment 200 may interconnect via wired connections, wireless connections, or a combination of wired and wireless connections.

The process control system 210 may include one or more devices capable of receiving, generating, storing, processing, providing, and/or routing information associated with controlling a software development process, as described elsewhere herein. The process control system 210 may include a communication device and/or a computing device. For example, the process control system 210 may include a server, such as an application server, a client server, a web server, a database server, a host server, a proxy server, a virtual server (e.g., executing on computing hardware), or a server in a cloud computing system. In some implementations, the process control system 210 may include computing hardware used in a cloud computing environment. In some implementations, the process control system 210 may correspond to the process control system 102 described in connection with FIGS. 1A-1C.

The development system 220 may include one or more devices capable of receiving, generating, storing, processing, providing, and/or routing information associated with a software development project, as described elsewhere herein. The development system 220 may include a communication device and/or a computing device. For example, the development system 220 may include a server, such as an application server, a client server, a web server, a database server, a host server, a proxy server, a virtual server (e.g., executing on computing hardware), or a server in a cloud computing system. In some implementations, the development system 220 may include computing hardware used in a cloud computing environment. In some implementations, the development system 220 may correspond to the development system 106 described in connection with FIGS. 1A-1C.

The communication system 230 may include one or more devices capable of receiving, generating, storing, processing, providing, and/or routing information associated with providing a communication channel, as described elsewhere herein. The communication system 230 may include a communication device and/or a computing device. For example, the communication system 230 may include a server, such as an application server, a client server, a web server, a database server, a host server, a proxy server, a virtual server (e.g., executing on computing hardware), or a server in a cloud computing system. In some implementations, the communication system 230 may include computing hardware used in a cloud computing environment. In some implementations, the communication system 230 may correspond to the communication system 108 described in connection with FIGS. 1A-1C.

The client device 240 may include one or more devices capable of receiving, generating, storing, processing, and/or providing information associated with completion of a software development project, as described elsewhere herein. The client device 240 may include a communication device and/or a computing device. For example, the client device 240 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device. In some implementations, the client device 240 may correspond to the client devices 104 described in connection with FIGS. 1A-1C.

The network 250 may include one or more wired and/or wireless networks. For example, the network 250 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 250 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with software development process control. The device 300 may correspond to process control system 210, development system 220, communication system 230, and/or client device 240. In some implementations, process control system 210, development system 220, communication system 230, and/or client device 240 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

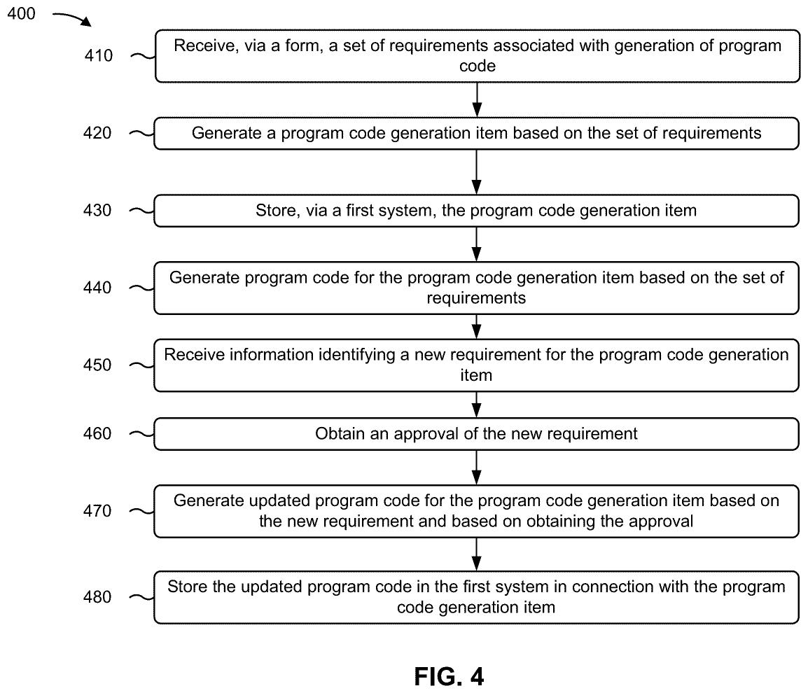

FIG. 4 is a flowchart of an example process 400 associated with software development process control. In some implementations, one or more process blocks of FIG. 4 may be performed by the process control system 210. In some implementations, one or more process blocks of FIG. 4 may be performed by another device or a group of devices separate from or including the process control system 210, such as the development system 220, the communication system 230, and/or the client device 240. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include receiving, via a form, a set of requirements associated with generation of program code (block 410). For example, the process control system 210 (e.g., using processor 320, memory 330, input component 340, and/or communication component 360) may receive, via a form, a set of requirements associated with generation of program code, as described above in connection with reference number 152 of FIG. 1A. As an example, the process control system 210 may provide an intake form with which to receive information identifying a request for software functionality to be added to an existing software component or for a new software component to be created with a particular software functionality.

As further shown in FIG. 4, process 400 may include generating a program code generation item based on the set of requirements (block 420). For example, the process control system 210 (e.g., using processor 320 and/or memory 330) may generate a program code generation item based on the set of requirements, as described above in connection with reference number 154 of FIG. 1B. As an example, the process control system 210 may create a new item in a software development management system with the set of requirements stored in the new item. Additionally, or alternatively, the process control system 210 may assign one or more program code writing tasks to one or more client devices used by one or more developers.

As further shown in FIG. 4, process 400 may include storing, via a first system, the program code generation item (block 430). For example, the process control system 210 (e.g., using processor 320 and/or memory 330) may store, via a first system, the program code generation item, as described above in connection with reference number 154 of FIG. 1B. As an example, the process control system 210 may store program code generation item in a development system to provide access to the program code generation item to a set of client devices.

As further shown in FIG. 4, process 400 may include generating program code for the program code generation item based on the set of requirements (block 440). For example, the process control system 210 (e.g., using processor 320 and/or memory 330) may generate program code for the program code generation item based on the set of requirements, as described above in connection with reference number 154 of FIG. 1B. As an example, the process control system 210 may use a program code generation component, such as an artificial intelligence component or a large language model component, to generate program code that performs one or more functionalities identified in the form. Additionally, or alternatively, the process control system 210 may assign one or more program code writing tasks to one or more client devices used by one or more developers and may receive program code from the one or more client devices as a response.

As further shown in FIG. 4, process 400 may include receiving information identifying a new requirement for the program code generation item (block 450). For example, the process control system 210 (e.g., using processor 320, memory 330, input component 340, and/or communication component 360) may receive information identifying a new requirement for the program code generation item, as described above in connection with reference number 158 of FIG. 1C. As an example, the process control system 210 may detect a command in a monitored communication channel and may interpret the command as identifying a new requirement for a software development project associated with the program code generation item.

As further shown in FIG. 4, process 400 may include obtaining an approval of the new requirement (block 460). For example, the process control system 210 (e.g., using processor 320 and/or memory 330) may obtain an approval of the new requirement, as described above in connection with reference number 160 of FIG. 1C. As an example, the process control system 210 may communicate with one or more systems to obtain the approval. In this case, the process control system may identify a client device with an approver characteristic (e.g., a client device used by a manager) and may transmit a notification identifying the new requirement to the client device and receive a response indicating an approval of the new requirement.

As further shown in FIG. 4, process 400 may include generating updated program code for the program code generation item based on the new requirement and based on obtaining the approval (block 470). For example, the process control system 210 (e.g., using processor 320 and/or memory 330) may generate updated program code for the program code generation item based on the new requirement and based on obtaining the approval, as described above in connection with reference number 162 of FIG. 1C. As an example, the process control system 210 may automatically generate new code or may assign a task to a client device to request new code to be generated.

As further shown in FIG. 4, process 400 may include storing the updated program code in the first system in connection with the program code generation item (block 480). For example, the process control system 210 (e.g., using processor 320 and/or memory 330) may store the updated program code in the first system in connection with the program code generation item, as described above in connection with reference number 162 of FIG. 1C. As an example, the process control system 210 may update the program code generation item with the updated program code and deploy the updated program code to, for example, a deployment environment for use.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1C. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for process control, the system comprising:
one or more memories; and
one or more processors, communicatively coupled to the one or more memories, configured to:
receive, via a first interface, a set of parameters for a software development project associated with generating program code;
generate a new software development project item for the software development project based on the set of parameters;
store, via a first system associated with a second interface, the new software development project item;
generate a monitored communication channel, operating on a second system, for the new software development project;
provision, on the second system, access to the monitored communication channel to a set of client devices associated with the software development project;
receive, based on a set of commands in the monitored communication channel, information identifying a new parameter for the software development project;
update the new software development project item in the first system based on the new parameter; and
provide information associated with updating the new software development project item.

2. The system of claim 1, wherein the one or more processors are further configured to:
generate first program code for the new software development project based on the set of parameters of the new software development project item;
provide the first program code based on generating the first program code; and
generate second program code, that is different from the first program code, based on the new parameter; and
wherein the one or more processors, to provide information associated with updating the new software development project item, are to:
provide the second program code.

3. The system of claim 1, wherein the one or more processors are further configured to:
provide, via the first interface, intake information associated with identifying the set of parameters for which a set of values are to be provided; and
wherein the one or more processors, to receive the set of parameters, are to:
receive, via input to the first interface, the set of values for the set of parameters.

4. The system of claim 1, wherein the one or more processors are further configured to:
identify, based on the set of parameters, the set of client devices associated with the software development project; and
transmit, to the set of client devices and based on identifying the set of client devices, information identifying one or more calendar items associated with the software development project.

5. The system of claim 1, wherein the one or more processors are further configured to:
transmit information identifying the update to a subset of client devices of the set of client devices; and
receive, from the subset of client devices, approval of the update; and
wherein the one or more processors, to update the new software development project, are to:
update the new software development project based on receiving approval of the update.

6. The system of claim 1, wherein the one or more processors are further configured to:
divide the new software development project into a set of tasks based on the set of parameters;
transmit, to the set of client devices, information identifying the set of tasks;
receive, from the set of client devices, information identifying completion of the set of tasks; and
update the new software development project based on the information identifying the completion of the set of tasks.

7. The system of claim 1, wherein the one or more processors are further configured to:
generate a set of test scripts for the new software development project;
execute the set of test scripts on program code of the new software development project; and
provide, via the monitored communication channel of the second system, information identifying a set of results of executing the set of test scripts.

8. The system of claim 1, wherein the one or more processors are further configured to:
receive a deployment command associated with the new software development project; and
configure a third system to deploy the new software development project on the third system.

9. A non-transitory computer-readable medium storing a set of instructions, the set of instructions comprising:
one or more instructions that, when executed by one or more processors of a system, cause the system to:
provide, to a client device, a user interface including a set of fields for receiving data;
receive, via a user interface, a set of values for the set of fields;
generate a new data item including the set of values for the set of fields;
store, via a data structure of a first system, the new data item;
generate, for the new data item and in connection with a second system, a communication channel;
provision, for a set of client devices, access to the communication channel on the second system;
receive, via the communication channel of the second system, information identifying a set of commands;
parse the set of commands to determine a change to a value of the set of values;
transmit an update notification to the first system to update the value in the new data item; and
transmit an update confirmation to the second system, for inclusion in the communication channel, indicating the update of the value of the new data item.

10. The non-transitory computer-readable medium of claim 9, wherein the one or more instructions, that cause the system to generate the new data item, cause the system to:
select, based on the set of values, an item template from a set of possible item templates; and
populate the set of values into the item template to generate a populated item template; and
wherein the one or more instructions, that cause the system to store the data item, cause the system to:
store the populated item template.

11. The non-transitory computer-readable medium of claim 10, wherein the item template includes a set of placeholder values that are replaced with the set of values.

12. The non-transitory computer-readable medium of claim 9, wherein the one or more instructions, that cause the system to store the new data item, cause the system to:
call an application programming interface of the first system to store the data item.

13. The non-transitory computer-readable medium of claim 9, wherein the one or more instructions, that cause the system to provide the user interface, further cause the system to:
provide the user interface via a serverless web application; and
wherein the one or more instructions, that cause the system to receive the set of values, cause the system to:
receive the set of values via one or more user interactions with the serverless web application.

14. The non-transitory computer-readable medium of claim 9, wherein the one or more instructions further cause the system to:
execute a test on program code of the data item;
detect an error associated with executing the test; and
update the data item with information identifying the error.

15. The non-transitory computer-readable medium of claim 14, wherein the one or more instructions further cause the system to:
transmit, to the set of client devices and via the second system, a set of notifications associated with the error.

16. A method, comprising:
receiving, by a device, via a form, a set of requirements associated with generation of program code;
generating, by the device, a program code generation item based on the set of requirements;
storing, by the device and via a first system, the program code generation item;
generating, by the device, program code for the program code generation item based on the set of requirements;
receiving, by the device, information identifying a new requirement for the program code generation item;
obtaining, by the device, an approval of the new requirement;
generating, by the device, updated program code for the program code generation item based on the new requirement and based on obtaining the approval; and
storing, by the device, the updated program code in the first system in connection with the program code generation item.

17. The method of claim 16, further comprising:
providing intake information associated with identifying the set of parameters for which a set of values are to be provided; and
wherein receiving the set of requirements comprises:
receiving, via input to a user interface, the set of values for the set of parameters.

18. The method of claim 17, further comprising:
identifying, based on the set of parameters, a set of client devices associated with the program code generation item; and
transmitting, to the set of client devices and based on identifying the set of client devices, information identifying one or more calendar items associated with the program code generation item.

19. The method of claim 18, further comprising:
transmitting information associated with the updated program code to a subset of client devices of the set of client devices; and
wherein obtaining the approval of the new requirement comprises:
receiving, from the subset of client devices, the approval of the new requirement.

20. The method of claim 16, further comprising:
dividing the program code generation item into a set of tasks based on the set of requirements;
transmitting, to a set of client devices, information identifying the set of tasks;
receiving, from the set of client devices, information identifying completion of the set of tasks; and
updating the program code generation item based on the information identifying the completion of the set of tasks.
